(19) United States
(12) Patent Application Publication
(10) Pub. No.: US 2019/0157978 A1
(43) Pub. Date: May 23, 2019

(54) MULTI-PHASE LLC CONVERTERS CONNECTED IN PARALLEL AND SERIES

(71) Applicant: Murata Manufacturing Co., Ltd., Nagaokakyo-shi, Kyoto-fu (JP)

(72) Inventor: Liqin NI, Westborough, MA (US)

(21) Appl. No.: 15/733,005

(22) PCT Filed: Jul. 27, 2017
(86) PCT No.: PCT/US2017/044119

§ 371 Date: Dec. 10, 2018

Related U.S. Application Data
(60) Provisional application No. 62/367,201, filed on Jul. 27, 2016.

(51) Int. Cl. H02M 3/335; H02M 1/14; H02M 1/08

(52) U.S. Cl. CPC H02M 3/33569; H02M 2001/0058; H02M 1/083; H02M 1/14

(57) ABSTRACT

A converter includes first and second phase circuits. Each of the first second phase circuits includes a transformer, a first switch and a second switch connected in series, and a resonant capacitor and a resonant inductor connected in series between the primary winding of the transformer and a node between the first switch and the second switch. The input voltage terminal of the converter is connected in parallel with the input of the first phase circuit and the input of the second phase circuit. The output voltage terminal of the converter is connected in series with the output of the first phase circuit and the output of the second phase circuit.

### BACKGROUND OF THE INVENTION

### 1. Field of the Invention

The present invention relates to LLC resonant converters. More specifically, the present invention relates to multi-phase LLC resonant converters connected in parallel and in series.

### 2. Description of the Related Art

LLC resonant converters are included in many different applications, such as flat panel TVs, LED lighting systems, and telecom applications. These different applications often require very high power density and efficiency. The switching frequency of the LLC resonant converters has increased so that the size of the magnetic components in the LLC resonant converters, e.g. transformers, can be decreased. Proper selection of the switching devices, e.g. transistors, in the LLC resonant converters helps to significantly reduce or prevent the switching losses in the switching devices.

An LLC resonant converter provides many advantages. An LLC resonant converter is able to regulate the output voltage over wide line and load variation with a relatively small variation in switching frequency. An LLC resonant converter is able to achieve zero-voltage switching (ZVS) without external control over the entire operation ranges of the switching frequencies and voltages. In ZVS, which is also referred to as soft switching or soft commutation, the power transistors are switched when the voltage applied to power transistors is zero. All essential parasitic elements, including junction capacitances of all semi-conductor devices and leakage inductance and magnetizing inductance of the transformer, are used to achieve ZVS. A switching frequency below the resonant frequency allows zero-current switching (ZCS) of the rectifier diodes or metal-oxide-semiconductor field-effect transistors (MOSFETs) in the secondary side.

A basic arrangement of an LLC resonant converter 10 is shown in FIG. 1. The LLC resonant converter 10 includes an input voltage V_{IN} that provides a direct current voltage and that is connected to power switches M_{UP}, M_{DN} that are connected in series with each other. A node connected between the power switches M_{UP}, M_{DN} is connected to resonant inductor L_{R}, the primary winding L_{M} (also referred to as the magnetizing inductor), and the resonant capacitor C_{R}. The transformer includes two secondary windings L_{S1}, L_{S2} coupled with the primary winding L_{M}. Primary side refers to the circuit connected to the primary winding L_{M}, and secondary side refers to the circuit connected to the secondary windings L_{S1}, L_{S2}. The primary-side circuit and the secondary-side circuit, although not directly connected to each other, are coupled together through the transformer. The turns ratio of the primary winding L_{M} to the secondary windings L_{S1}, L_{S2}is N₁:N₂, where N₁ is the number of turns in the primary winding L_{M} and N₂ is the number of turns in each of the secondary windings L_{S1}, L_{S2}. Each of the secondary windings L_{S1}, L_{S2} is connected to one of the rectifiers D₁, D₂. The output capacitor C_{OUT} is connected to the rectifiers D₁, D₂. An output voltage V_{OUT} is provided by the output capacitor C_{OUT}. The output voltage level provided by the output voltage V_{OUT} is proportional to the voltage level provided by the input voltage V_{IN}, based on the turns ratio.

The LLC resonant converter 10 in FIG. 1 has the advantages of ZVS and ZCS on the rectifiers D₁, D₂ when the switching frequency is lower than the resonant frequency. However, the topology of the LLC resonant converter 10 results in a large current ripple on the output filter capacitor C_{OUT} because of the rectified sine-wave current injected through the transformer secondary windings L_{S1}, L_{S2}.

U.S. Pat. No. 6,970,366 discloses that using multiple phases as shown in FIG. 2 can reduce the capacitor size. Using multiple phases can be referred to as interleaving. FIG. 2 shows an LLC resonant converter 20 with three phases connected in parallel. Each of the phases of the LLC resonant converter 20 shown in FIG. 2 is arranged similar to the single-phase LLC resonant converter 10 shown in FIG. 1. Each phase resonant capacitor C_{Ri}, resonant inductor L_{Ri}, and primary winding L_{Mi} with i=1, 2, 3, is connected in series on the primary side. Each pair of secondary windings L_{Si1}, L_{Si2} with i=1, 2, 3 are coupled to a respective one of the primary windings L_{Mi} and connected to the output capacitor C_{OUT} via respective rectifiers Dᵢ₁, Dᵢ₂ with i=1, 2, 3.

Ideally, the simple parallel connection with phase shift shown in FIG. 2 can drastically reduce the output current ripple as compared to the single phase topology shown in FIG. 1. However, in real-world applications, imbalances in current or power among the different phases can be significant due to resonant components being mismatched.

### SUMMARY OF THE INVENTION

Preferred embodiments of the present invention provide two-phase LLC resonant converters according to preferred embodiments of the present invention with inputs connected in parallel and outputs connected in series, which are able to provide one or more of the following benefits:
a) Significant reduction in voltage stress on the components on the secondary side of the LLC resonant converter, significant reduction in current stress on the components on the primary side of the LLC resonant converter, and significant reduction of conduction losses in the primary switches on the primary side of the LLC resonant converter.
b) Automatic minimization or significant reduction in the current or power imbalance between the phases of the multiphase LLC resonant converter.
c) Significant reduction in input current ripple and/or output current ripple with phase shift control of gate signals for the primary switches on the primary side of the LLC resonant converter.
d) Significant reduction in the startup current if each phase has a different start time.
e) The LLC resonant converter is able to be controlled by a single controller and/or a single feedback loop.

According to a preferred embodiment of the present invention, a converter includes an input voltage terminal, a first phase circuit, and a second phase circuit, and an output voltage terminal. Each of the first phase circuit and the second phase circuit includes a transformer including a primary winding and at least two secondary windings; a series circuit connected between the input voltage terminal and the primary winding, the series circuit including a first switch and a second switch connected in series and a resonant capacitor and a resonant inductor connected in series between the primary winding and a node between the first switch and the second switch; and a half-bridge rectifier circuit connected between the at least two secondary windings and the output voltage terminal. The at least two secondary windings of the first phase circuit are separate from the at least two secondary windings of the second phase circuit. The input voltage terminal is connected in parallel with an input of the first phase circuit and an input of the second phase circuit. The output voltage terminal is connected in series with an output of the first phase circuit and an output of the second phase circuit.

Preferably, the half-bridge rectifier circuit of each of the first phase circuit and the second phase circuit includes an output capacitor and at least a first rectifier and a second rectifier; the first rectifier is connected between a first secondary winding of the at least two secondary windings and a first end of the output capacitor; and the second rectifier is connected between a second secondary winding of the at least two secondary windings and the first end of the output capacitor. A second end of the output capacitor is preferably connected to a node between the first secondary winding and the second secondary winding. Each of the first rectifier and the second rectifier is preferably a diode. Preferably, an anode of the first rectifier is connected to the first secondary winding; a cathode of the first rectifier is connected to the first end of the output capacitor; an anode of the second rectifier is connected to the second secondary winding; and a cathode of the second rectifier is connected to the first end of the output capacitor. Each of the first rectifier and the second rectifier is preferably a synchronous metal-oxide-semiconductor field-effect transistor (MOSFET). The output capacitor of the first phase circuit is preferably connected in series with the output capacitor of the second phase circuit. The converter further preferably includes a converter output capacitor connected in parallel with the output capacitors of the first and second phase circuits. The half-bridge rectifier circuit preferably does not include any switch located between the at least two secondary windings and the output capacitor.

Each of the first switch and the second switch is preferably a transistor. Each of the first switch and the second switch is preferably a metal-oxide-semiconductor field-effect transistor (MOSFET).

The converter further preferably includes a controller that receives an output-voltage-sense signal related to an output voltage at the output voltage terminal and outputs a control signal to each of the first and second switches of each of the first and second phase circuits. A frequency of the control signal output to the first switch of the first phase circuit is preferably a same or substantially a same frequency as a frequency of the control signal output to the first switch of the second phase circuit. A phase of the control signal output to the first switch of the first phase circuit is preferably a same or substantially a same phase as a phase of the control signal output to the first switch of the second phase circuit, is preferably a shifted by about 90° from a phase of the control signal output to the first switch of the second phase circuit, or is a shifted by about 180° from a phase of the control signal output to the first switch of the second phase circuit. During startup of the converter, the controller preferably delays starting the second phase circuit by a predetermined period of time after starting the first phase circuit.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 is a circuit diagram of a known single-phase LLC resonant converter.

FIG. 2 is a circuit diagram of a known three-phase LLC resonant converter.

FIG. 3 is a circuit diagram of a two-phase LLC resonant converter according to a preferred embodiment of the present invention.

FIGS. 4A, 4B, and 4C show waveforms of phase currents and total currents for an LLC resonant converter according to preferred embodiments of the present invention.

FIGS. 5A, 5B, and 5C are graphs showing the input voltage/power differential ratio with respect to normalized switching frequency according to preferred embodiments of the present invention.

FIG. 6 is a graph showing typical gain curves for an LLC resonant converter according to a preferred embodiment of the present invention.

FIG. 7 is a circuit diagram of a multi-phase LLC resonant converter according to a preferred embodiment of the present invention.

FIG. 8 is a graph showing a typical gain curve for a known single phase LLC resonant converter.

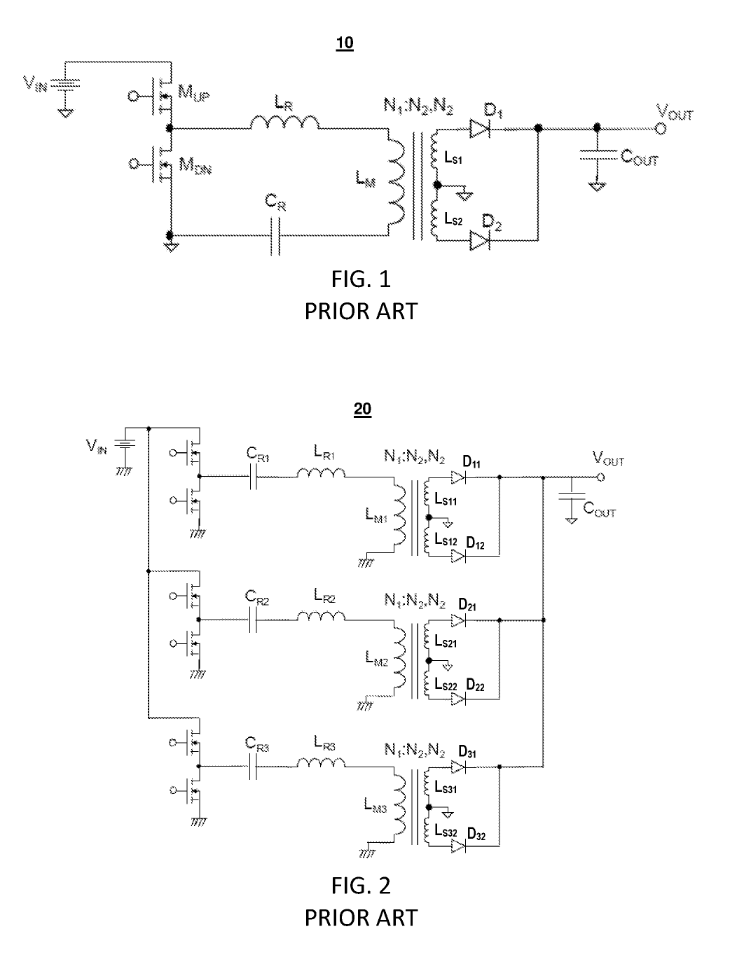

### DETAILED DESCRIPTION OF PREFERRED EMBODIMENTS

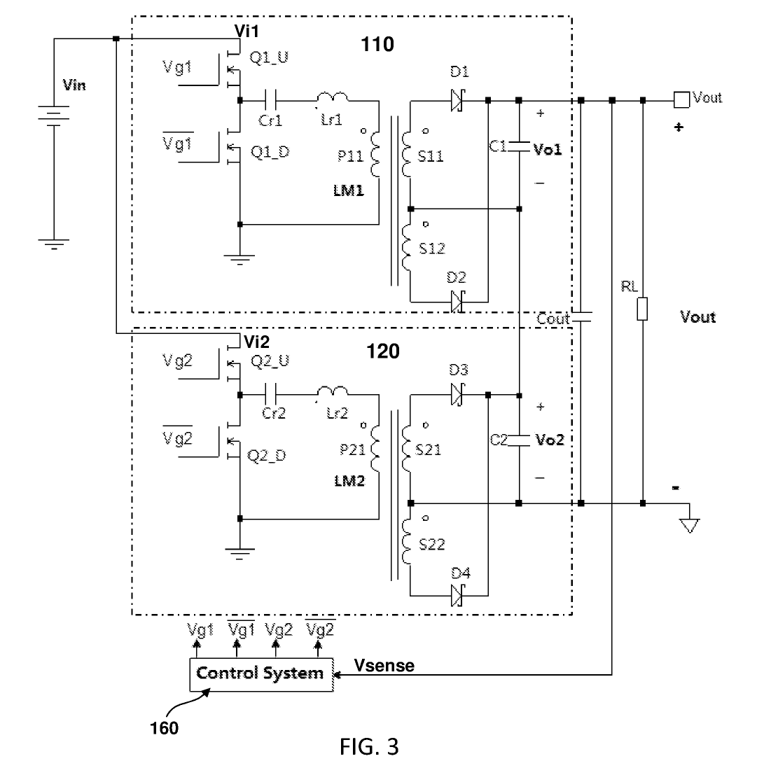

Preferred embodiments of the present invention will now be described in detail with reference to FIGS. 3 to 7. Note that the following description is in all aspects illustrative and not restrictive and should not be construed to restrict the applications or uses of the present invention in any manner.

FIG. 3 is a circuit diagram of a two-phase LLC resonant converter 100 according to a preferred embodiment of the present invention, and includes two phase circuits 110, 120 with phase input voltages Vi1, Vi2 connected in parallel and phase output voltages Vo1, Vo2 connected in series.

The converter 100 includes an input voltage V_{IN} that provides a direct current voltage to both the first phase circuit 110 and the second phase circuit 120. The first phase circuit 110 includes power switches Q1_U, Q1_D that are connected in series with each other. A node connected between the power switches Q1_U, Q1_D is connected to a resonant capacitor Cr1. The resonant capacitor Cr1 is connected to a resonant inductor Lr1. The resonant inductor Lr1 is connected to a magnetizing inductor Lm1 of a primary winding P11 in the first phase circuit 110. The transformer includes two secondary windings S11, S12 in the first phase circuit 110 coupled with the primary winding P11 in the first phase circuit 110. Each of the secondary windings S11, S12 in the first phase circuit 110 is connected to an anode of one of two rectifiers D1, D2. An output capacitor C1 is connected to a cathode of each of the rectifiers D1, D2.

The second phase circuit 120 includes power switches Q2_U, Q2_D that are connected in series with each other. A node connected between the power switches Q2_U, Q2_D is connected to a resonant capacitor Cr2. The resonant capacitor Cr2 is connected to a resonant inductor Lr2. The resonant inductor Lr2 is connected to magnetizing inductor Lm2 of a primary winding P21 in the second phase circuit 120. The transformer includes two secondary windings S21, S22 in the second phase circuit 120 coupled with the primary winding P21 in the second phase circuit 120. Each of the secondary windings S21, S22 in the second phase circuit 120 is connected to an anode of one of two rectifiers D3, D4. An output capacitor C2 is connected to a cathode of each of the rectifiers D3, D4.

Preferably, the components and the circuit arrangement of the second phase circuit 120 are similar to the components and the circuit arrangement of the first phase circuit 110. Including similar components and circuit arrangements in the first phase circuit 110 and the second phase circuit 120 significantly reduces mismatches in voltage and power between the first phase circuit 110 and the second phase circuit 120 to significantly improve overall performance of the converter 100. For example, any mismatching between resonant circuit components can be compensated by the similar circuit arrangements of the first phase circuit 110 and the second phase circuit 120, as discussed further below.

The half-bridge arrangement of the power switches in the first phase circuit 110 and second phase circuit 120 includes fewer components and provides simpler control than a full-bridge arrangement. Thus, the resonant inductors Lr1, Lr2 are able to be integrated into the respective transformers, for example, to significantly reduce the size of the LLC converter 100, when compared with connecting the resonant inductors Lr1, Lr2 to the magnetizing inductor Lm1 of the primary winding P1 in the first phase or the second phase. However, even if separate (i.e., non-integrated) resonant inductors Lr1, Lr2 are included, the LLC converter 100 is still able to be made smaller than a converter including a full-bridge arrangement. The arrangement of resonant components on the primary side of the first phase circuit 110 and second phase circuit 120 provides higher energy transfer from the primary side to the secondary side than a full-bridge arrangement. Further, including two rectifiers D1, D2 or D3, D4 is simpler and provides lower voltage drop than a full-bridge rectification circuit.

An output voltage Vout is provided by the output capacitors C1 and C2 connected in series. The converter 100 includes an output capacitor Cout connected in parallel with the series connected output capacitors C1 and C2. The power switches Q1_U, Q1_D, Q2_U, Q2_D are, for example, MOSFETs, although other suitable transistors may be included. In addition, instead of diodes D1, D2, D3, D4, synchronous MOSFETs may be included to rectify the voltage in the secondary-side circuits, for example.

A control system 160 of the converter 100, as shown in FIG. 3, receives an output-voltage-sense signal Vsense related to the output voltage Vout. Preferably, the converter 100 includes only a single controller, the control system 160, that controls both the first phase circuit 110 and the second phase circuit 120. The control system 160 may be provided, for example, by programming a microcontroller system. However, the control system 160 may instead be implemented by a logic circuit (hardware) provided in an integrated circuit (IC chip) or as software executed by a CPU (Central Processing Unit), for example.

The control system 160 may include an analog-to-digital converter (ADC), for example, and may be programmed to include a feedback control algorithm that determines switch timing and outputs control signals Vg1, Vg2. The control system 160 provides, based in part on the output-voltage-sense signal Vsense, a control signal Vg1 to drive power switches Q1_U, Q1_D and a control signal Vg2 to drive power switches Q2_U, Q2_D. Preferably, the control system includes only a single feedback loop, that is, the output-voltage-sense signal Vsense, to regulate the output voltage Vout by controlling the power switches Q1_U, Q1_D, Q2_U, 02_D. However, separate feedback loops may instead be included for each of the output voltages Vo1, Vo2 of the first and second phase circuits 110, 120.

Control signals Vg1 and Vg2 are able to be output at the same or substantially the same frequency or at different frequencies. The current transmitted through the power switches Q1_U, Q1_D, Q2_U, Q2_D is reduced by half compared to a single phase. The transmitted current is reduced by half because each of the first phase circuit 110 and second phase circuit 120 handles half of the power so that the current in the primary side is only half of the total current. The conduction losses in each of power switches Q1_U, Q1_D, Q2_U, Q2_D is reduced to a quarter because the conduction loss is provided by the equation (0.5*I)²*Rdson, where 0.5*I is the current through one of the switches and Rdson is the ON resistance of the switch. This significant reduction in conduction losses allows for a variety of different types of MOSFETs to be included as the power switches. The voltage stress on the diodes D1, D2, D3, D4 is able to be reduced by half compared to single phase because the secondary side is connected in series so that the voltage in each output is Vout/2. In a single phase with output Vout, the voltage stress on the diodes is 2×Vout. Thus, because the voltage stress is approximately halved, a variety of different diodes may be included as the diodes D1, D2, D3, D4 of the converter 110, including diodes that have lower cost.

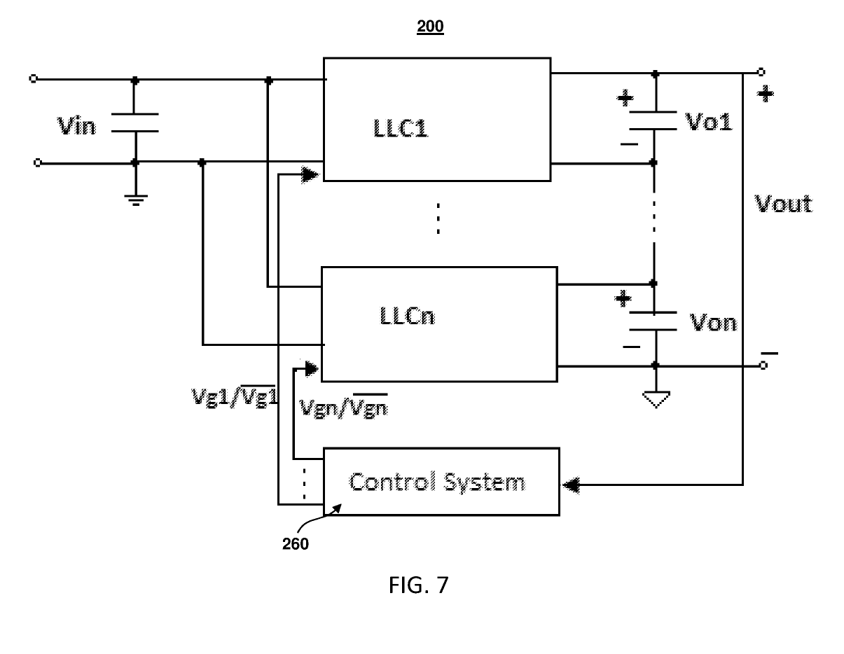

The converter 100 may be modified, for example, to include more than two phases. FIG. 7 is a circuit diagram of a multi-phase LLC resonant converter 200 with the inputs connected in parallel and the outputs connected in series. The converter 200 in FIG. 7 includes n phase circuits LLC1, . . . , LLCn. A control system 260 of the multi-phase LLC resonant converter 200 provides control signals Vg1, . . . , Vgn to the n phase circuits LLC1, . . . , LLCn. All of the phase circuits LLC1, . . . , LLCn may be operated at the same or substantially the same time, or only some of the phase circuits LLC1, . . . , LLCn (e.g., only phase circuits LLC1 and LLC2) may be operated at the same or substantially the same time, for example. By turning on or off the phase circuits LLC1, . . . , LLCn, the output voltage range is able to be increased or decreased. Preferably, for example, each of the n phase circuits LLC1, . . . , LLCn includes components similar to those included in the first phase circuit 110 or the second phase circuit 120 shown in FIG. 3, and the control system 260 is a controller that is similar to the controller 160 shown in FIG. 3.

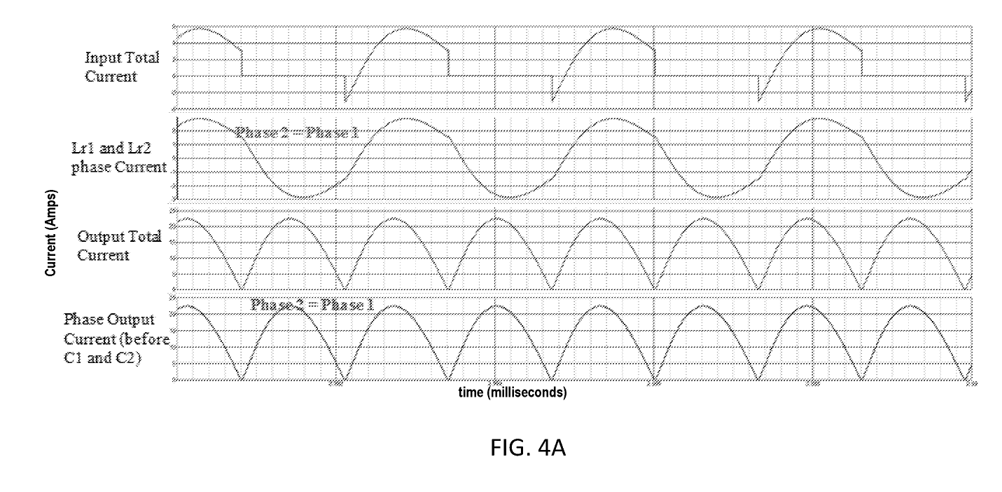

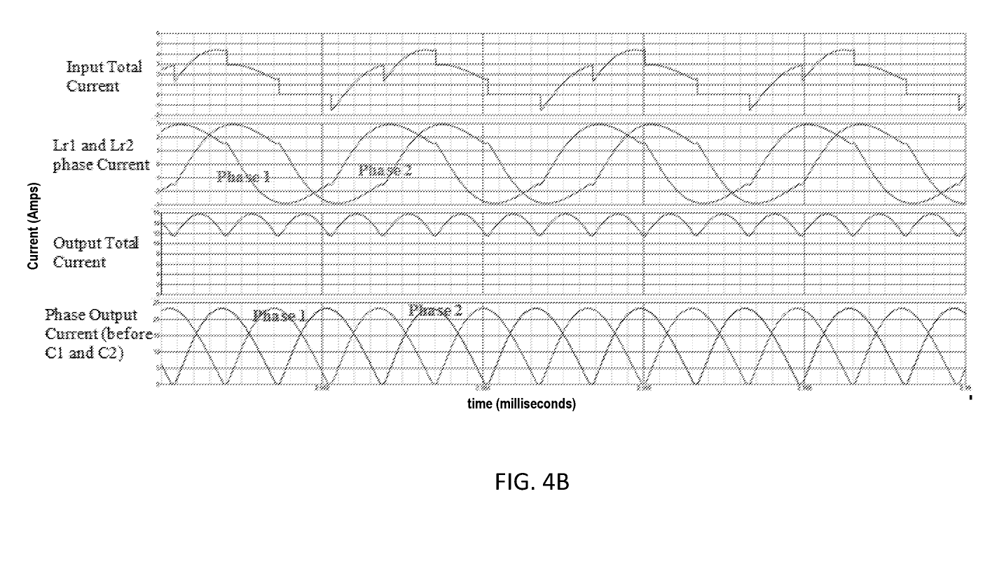

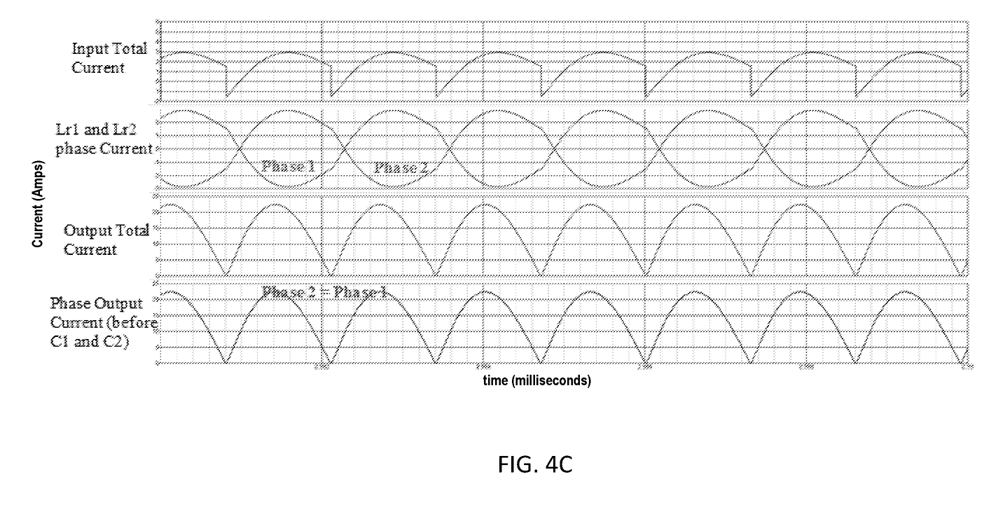

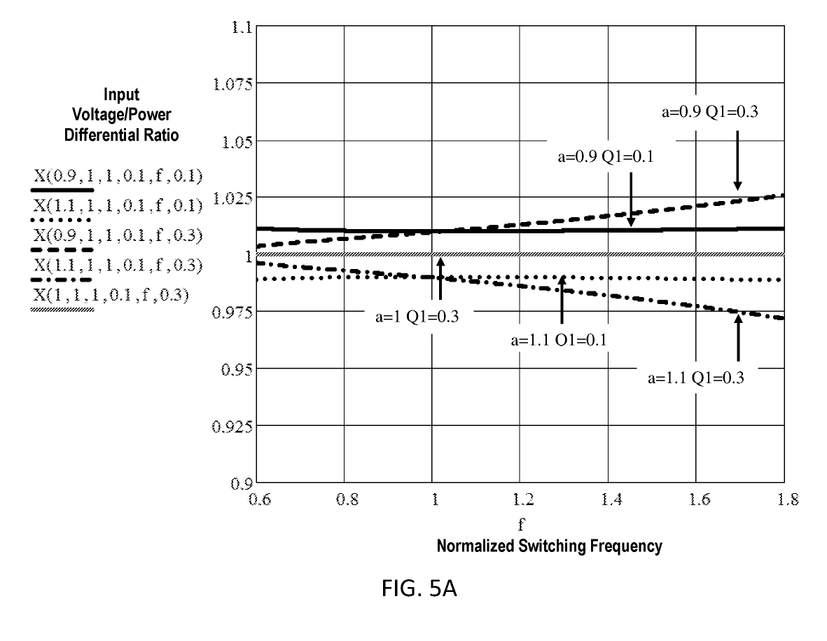

FIGS. 4A-4C are current waveforms at the same or substantially the same switching frequency for two phase circuits but with different phase shift control according to preferred embodiments of the present invention. FIG. 4A shows about 0° phase shift (i.e., without or substantially without phase shift). The two phase circuits have the same or substantially the same control signals Vg1 and Vg2. In FIG. 4B, the two phase circuits have the same or substantially the same switching frequency but are about 90° phase shifted between the control signals Vg1 and Vg2. In FIG. 4C, the two phase circuits have the same or substantially the same switching frequency but are about 180° phase shifted between the control signal Vg1 and Vg2. Small variations in the switching frequencies between the two phases, whether 0°, 90°, or 180° phase shift, are acceptable as long as the output current ripple is acceptable. Comparing these three phase-shifted conditions, 0°-phase shift has the largest current ripples for both the input current and the output current; 180°-phase shift has the lowest input current ripple but the output current ripple is similar to the 0°-phase shift; and the 90°-phase shift has the lowest output current ripple, and the input current ripple is smaller than the 0°-phase shift and larger than 180°-phase shift. Thus, the input/output current ripple level depends on the phase shift angle. In the converter 100 shown in FIG. 3, the phase shift angle is able to be pre-set to significantly improve or maximize the whole system performance or to significantly reduce or minimize filter size. For example, the phase shift angle is able to be set to 90° to decrease the output current ripple or is able to be set to 180° to decrease the input current ripple, depending on the particular application. The phase shift angle is able to be set by the control system 160 or is able to be dynamically controlled by the control system 160.

During startup of a two-phase LLC resonant converter 100 in FIG. 3 described above, the input current is the sum of two phase currents. Each phase of the two-phase LLC resonant converter, for example, the first phase circuit 110 and the second phase circuit 120 described above, has a current I_st1, I_st2 at startup. If the two phase circuits start at the same or substantially the same time, then the sum of startup currents is the sum of I_st1 and I_st2. The startup times can be the same or can be different so long as the sum of startup currents do not result in overshoot conditions. If the first phase circuit is started first, then the startup current is only I_st1. If the second phase circuit starts after some time delay, where the delay time depends on the LLC startup frequency, dead time, and other converter components and with typical delay times in the range of tens of ms to hundreds of ms, then the total input current is I1+I_st2 (I1<<I_st1), where I1 is the steady state current, when the second phase circuit is started. During startup transition, the input peak current is able be significantly reduced by delaying one of phase circuits. If the two phase circuits are started at the same or substantially the same time, then the peak current is the sum of I_st1 and I_st2. If the start of the second phase circuit is delayed, then the peak current is I1+I_st2, which is smaller than I_st1+I_st2.

An automatic minimization or a significant reduction of the power/current imbalance for two phase circuits is provided when the control signals for the primary-side switches, for example, control signals Vg1 and Vg2, have the same or substantially the same switch frequency. If the difference between the switching frequencies of the control signals Vg1 and Vg2 is small, then the power imbalance between the phase circuits, for example, the first phase circuit 110 and the second phase circuit 120 described above, is able to be made relatively small.

In LLC resonant converter, the load factor Q is defined as:

$$\begin{matrix}Q := \frac{\sqrt{\frac{Lr}{Cr}}}{Rac} , & ( Equation 1 ) \\ where & \\ Rac = \frac{8 \cdot {n}^{2}}{{π}^{2}} \cdot Ro . & ( Equation 2 )\end{matrix}$$

In Equations 1 and 2, Lr is the resonant inductance, Cr is the resonant capacitance, Rac is the effective resistive load reflected to the AC resonant tank on the primary side of the transformer, n is the turns ratio of the transformer, and Ro is the load resistance.

Thus, the load factor Q is scaled with the output power Pout, where Pout=Vout²/Ro.

Applying fundamental approximation analysis for an LLC resonant converter, “AN2450 Application note, LLC resonant half-bridge converter design guideline” (Revision 5) October 2007, provides the output voltage gain M=Vo/2nVin as:

$$M ( fn , λ , Q ) = \frac{1}{\sqrt{{( 1 + λ - \frac{λ}{{fn}^{2}} )}^{2} + {Q}^{2} \cdot {( fn - \frac{1}{fn} )}^{2}}} . \qquad ( Equation 3 )$$

In Equation 3, n is the turns ratio of the transformer, Lr is the resonant inductance, Cr is the resonant capacitance, Lm is the transformer inductance, M is the voltage gain, λ is the inductance ratio Lr/Lm, fn is the normalized switch frequency fn=fsw/fr (where fsw is the switching frequency and fr is the resonant frequency), and Ro is the load resistance.

When the two phase output voltages are connected in series, and the phase input voltages are connected in parallel, for example, as shown in FIG. 3, the relationship between Q and M is provided by the equation below. If the two phase circuits have the same or substantially the same efficiency, then the power difference ratio X between the two phase circuits has the following relationship:

$$X = \frac{Po 2}{Po 1} = \frac{Vo 2}{Vo 1} = \frac{M 2}{M 1} = \frac{Q 1}{Q 2} \sqrt{\frac{Lr 2 Cr 1}{Lr 1 Cr 2}} . \qquad ( Equation 4 )$$

From the above Equations 1 to 4, the difference ratio X is able to be determined as a function of the values of the resonant components:

$$X ( a , b , c , λ 1 , f 1 , Q 1 ) := \sqrt{\frac{\frac{1}{{M ( f 1 , λ 1 , Q 1 )}^{2}} - Q {1}^{2} \cdot {( a \cdot f 1 - \frac{1}{b \cdot f 1} )}^{2}}{{( 1 + \frac{a}{c} \cdot λ 1 - \frac{λ 1}{b \cdot cf {1}^{2}} )}^{2}}} . \qquad ( Equation 5 )$$

In Equations 4 and 5, a is the resonant inductance ratio between the two phase circuits (a=Lr2/Lr1), b is the resonant capacitance ratio between the two phase circuits (b=Cr2/Cr1), c is the transformer inductance difference ratio between the two phase circuits (c=Lm2/Lm1), λ1 is inductance ratio Lr1/Lm1 for the first phase circuit, f1 is the normalized switching frequency for the first phase circuit (f1=fsw/fr1), and fr1 is defined by the following equation:

$$fr 1 = \frac{1}{2 \cdot π \sqrt{Lr 1 \cdot Cr 1}} , \qquad ( Equation 6 )$$

and Q1 is the load factor for the first phase circuit.

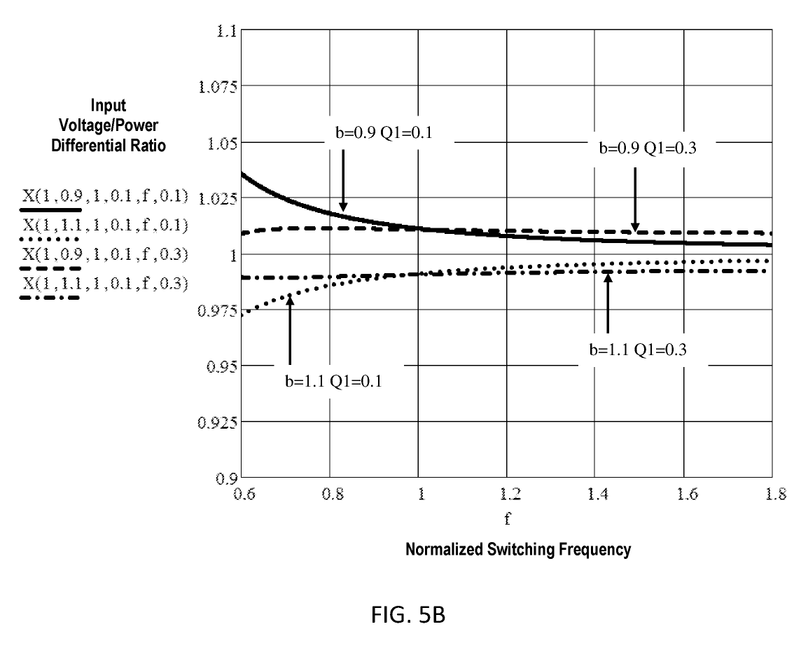

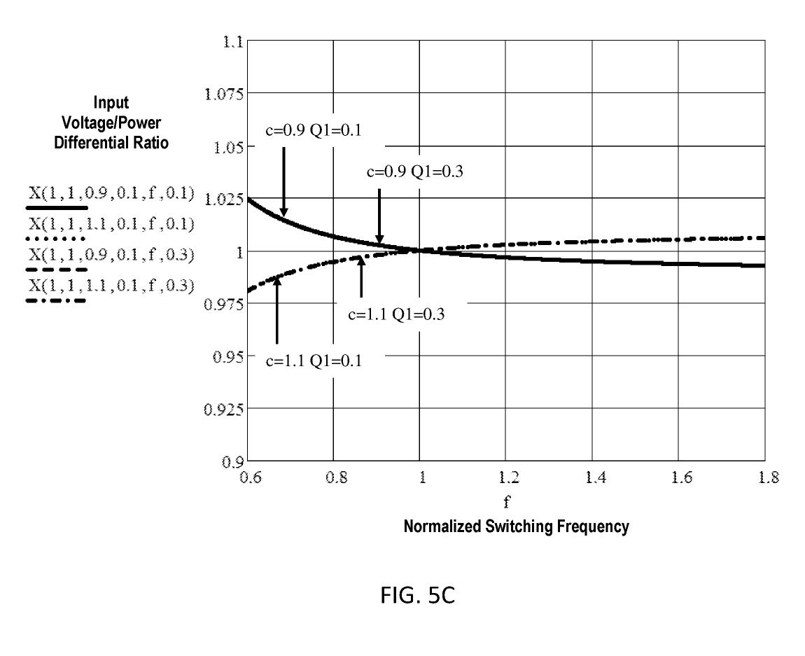

If a current or power imbalance between the two phase circuits occurs, such an imbalance is most likely due to mismatches in the resonant components of the two phase circuits. FIGS. 5A, 5B, and 5C show the difference ratio X versus the normalized switching frequency for λ and Q according to preferred embodiments of the present invention. FIG. 5A shows the difference ratio X when a=Lr2/Lr1=0.9 or 1.1 and the other two components Lm and Cr are the same or substantially the same; FIG. 5B shows the difference ratio X when b=Cr2/Cr1=0.9 or 1.1 and the other two components Lr and Lm are the same or substantially the same; and FIG. 5C shows the difference ratio X when c=Lm2/Lm1=0.9 or 1.1 and the other two components Lr and Cr are the same or substantially the same.

From the relationships shown in FIGS. 5A-5C, with a ±10% mismatch in the resonant components, the mismatch voltage or mismatch power between the two phase circuits is able to be made less than ±5% for a given condition and frequency operation range, without applying any additional control. The output voltage or power mismatch is also able to be decreased further with a smaller operating frequency range, for example. In addition, the power imbalance level is able to be easily checked by monitoring the output voltages of the two phase circuits, for example, output voltages Vo1 and Vo2 shown in FIG. 3.

For an entire two-phase LLC resonant converter system with two phase output voltages connected in series, for example, the two-phase LLC resonant converter 100 as shown in FIG. 3, the system voltage gain is obtained if the system gain M_sys is defined as n*Vout/Vin (the turns ratio n of the transformer multiplied by the ratio of the output voltage Vout to the input voltage Vin):

$$M\_sys ( a , b , c , λ 1 , f 1 , Q 1 ) = \frac{1 + X ( a , b , c , λ 1 , f 1 , Q 1 )}{2} M ( f 1 , λ 1 , Q 1 ) . \qquad ( Equation 7 )$$

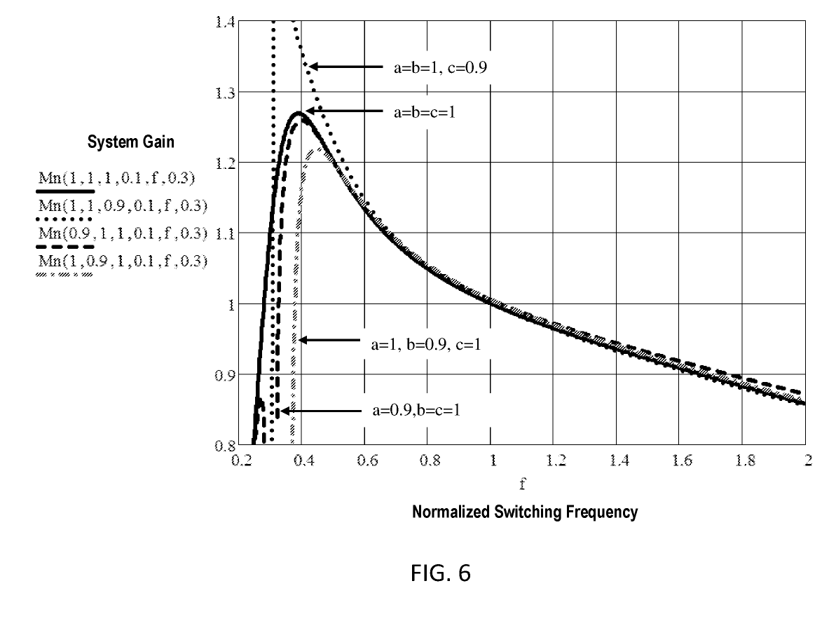

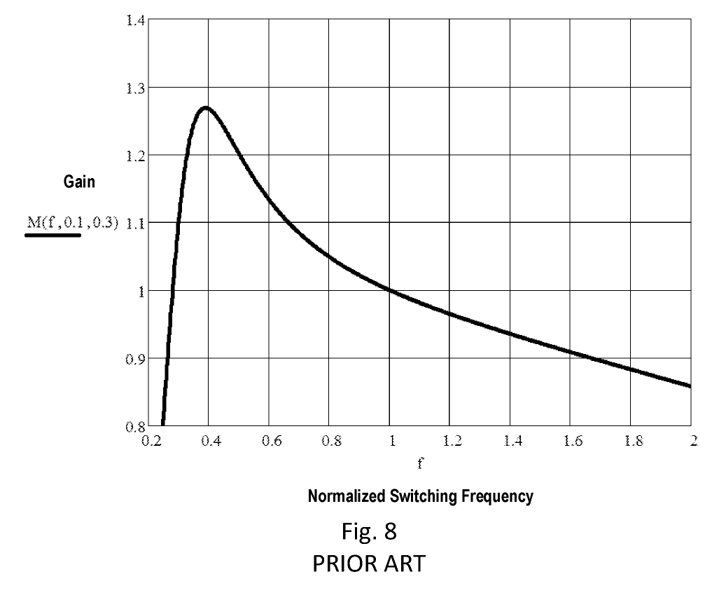

FIG. 6 shows gain curves for the two-phase LLC resonant converter 100 of FIG. 3 according to a preferred embodiment of the present invention. As shown in FIG. 6, the two-phase LLC resonant converter with the phase output voltages connected in series provides gain curves that are similar to gain curves for a single phase LLC resonant converter, such as shown in FIG. 8. FIG. 8 shows a typical gain curve for a known single phase LLC resonant converter with an inductance ratio λ=Lr/Lm=0.1 and a load factor Q=0.3, and a normalized switching frequency. Thus, the control system for a two-phase LLC resonant converter with the phase output voltages connected in series is able to be made similar to the control system for a single-phase LLC resonant converter.

It should be understood that the foregoing description is only illustrative of the present invention. Various alternatives and modifications will be apparent to those skilled in the art without departing from the present invention. Accordingly, the present invention is intended to embrace all such alternatives, modifications, and variances that fall within the scope of the appended claims.

What is claimed is:

1. A converter comprising:
an input voltage terminal;
a first phase circuit; and
a second phase circuit; and
an output voltage terminal; wherein each of the first phase circuit and the second phase circuit includes:
a transformer including a primary winding and at least two secondary windings;
a series circuit connected between the input voltage terminal and the primary winding, the series circuit including:
a first switch and a second switch connected in series; and
a resonant capacitor and a resonant inductor connected in series between the primary winding and a node between the first switch and the second switch; and
a half-bridge rectifier circuit connected between the at least two secondary windings and the output voltage terminal;
the at least two secondary windings of the first phase circuit are separate from the at least two secondary windings of the second phase circuit;
the input voltage terminal is connected in parallel with an input of the first phase circuit and an input of the second phase circuit; and
the output voltage terminal is connected in series with an output of the first phase circuit and an output of the second phase circuit.

2. The converter according to claim 1, wherein:
the half-bridge rectifier circuit of each of the first phase circuit and the second phase circuit includes an output capacitor and at least a first rectifier and a second rectifier;
the first rectifier is connected between a first secondary winding of the at least two secondary windings and a first end of the output capacitor; and
the second rectifier is connected between a second secondary winding of the at least two secondary windings and the first end of the output capacitor.

3. The converter according to claim 2, wherein a second end of the output capacitor is connected to a node between the first secondary winding and the second secondary winding.

4. The converter according to claim 2, wherein each of the first rectifier and the second rectifier is a diode.

5. The converter according to claim 4, wherein
an anode of the first rectifier is connected to the first secondary winding, and a cathode of the first rectifier is connected to the first end of the output capacitor; and
an anode of the second rectifier is connected to the second secondary winding, and a cathode of the second rectifier is connected to the first end of the output capacitor.

6. The converter according to claim 2, wherein each of the first rectifier and the second rectifier is a synchronous metal-oxide-semiconductor field-effect transistor (MOSFET).

7. The converter according to claim 2, wherein the output capacitor of the first phase circuit is connected in series with the output capacitor of the second phase circuit.

8. The converter according to claim 2, further comprising a converter output capacitor connected in parallel with the output capacitors of the first and second phase circuits.

9. The converter according to claim 2, wherein the half-bridge rectifier circuit does not include any switch located between the at least two secondary windings and the output capacitor.

10. The converter according to claim 1, wherein each of the first switch and the second switch is a transistor.

11. The converter according to claim 10, wherein each of the first switch and the second switch is a metal-oxide-semiconductor field-effect transistor (MOSFET).

12. The converter according to claim 1, further comprising a controller that receives an output-voltage-sense signal related to an output voltage at the output voltage terminal and outputs a control signal to each of the first and second switches of each of the first and second phase circuits.

13. The converter according to claim 12, wherein a frequency of the control signal output to the first switch of the first phase circuit is a same or substantially a same frequency as a frequency of the control signal output to the first switch of the second phase circuit.

14. The converter according to claim 13, wherein a phase of the control signal output to the first switch of the first phase circuit is a same or substantially a same phase as a phase of the control signal output to the first switch of the second phase circuit.

15. The converter according to claim 13, wherein a phase of the control signal output to the first switch of the first phase circuit is a shifted by about 90° from a phase of the control signal output to the first switch of the second phase circuit.

16. The converter according to claim 13, wherein a phase of the control signal output to the first switch of the first phase circuit is a shifted by about 180° from a phase of the control signal output to the first switch of the second phase circuit.

17. The converter according to claim 12, wherein, during startup of the converter, the controller delays starting the second phase circuit by a predetermined period of time after starting the first phase circuit.
